(19) United States
(12) Patent Application Publication
(10) Pub. No.: US 2011/0198186 A1
(43) Pub. Date: Aug. 18, 2011

(54) Electrically actuated clutch operator and method of use

(76) Inventor: Jeffrey H. Schweyer, Aztec, NM (US)

(21) Appl. No.: 12/932,095

(22) Filed: Feb. 17, 2011

Related U.S. Application Data
(60) Provisional application No. 61/338,405, filed on Feb. 18, 2010.

(51) Int. Cl. F16D 28/00

(52) U.S. Cl. 192/84.1

(57) ABSTRACT

The present invention is an electrically actuated clutch operator for the clutch of a rotational motor. The invention can be used to operate a variety of clutch types for both AC and DC motors. The present invention comprises a mounting plate, a generally T-shaped adapter arm that attaches to the operating shaft of the clutch, two electrical linear actuators, two corresponding eight-terminal relays and a programmable relay that controls activation of the actuators. To engage the clutch, one actuator's ram thrusts into the adapter arm, moving the operating shaft to an activated position. To disengage the clutch the other actuator's ram thrusts into a different section of the adapter arm, moving the operating shaft to an inactivate position. The preferred embodiment is designed for an over-center, in-and-out power take-off clutch.

### CROSS-REFERENCE TO RELATED APPLICATION

I hereby claim the benefit under Title 35, United States Code Section 119(e) of any U.S. Provisional Application(s) listed below:

### Application No. 61/338,405

### Filing Date Feb. 18, 2010

### STATEMENT REGARDING FEDERALLY SPONSORED RESEARCH AND DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION

1. Field of the Invention

The present invention generally relates to a clutch operator and a method of using the same. More particularly, the present invention relates to a mechanical clutch operator comprising two electrical actuators capable of automatically engaging and disengaging an over-center, in-and-out, power-take-off (“PTO”) type clutch.

2. Description of the Related Art Including Information Disclosed Under 37 CFR 1.97 and 37 CFR 1.98

The following description of the art related to the present invention refers to a number of publications and references. Discussion of such publications herein is given to provide a more complete background of the scientific principles related to the present invention and is not to be construed as an admission that such publications are necessarily prior art for patentability determination purposes.

Clutch operators comprising similar elements and methods of use as the clutch operator of this invention are well-known. For example, FW Murphy, CO3-12 and CO3-24 (the “FW Murphy”) is a clutch operator that latches onto the handle of the clutch. The design of the FW Murphy presents several operational problems. When the clutch comes slightly out of adjustment due to normal use, the FW Murphy clutch operator fails to relieve pressure to the handle while the clutch is engaged unless an actuator adjustment is performed. If an actuator adjustment is not performed within a few days, it will cause the clutch's brass sleeve to wear to the point of requiring costly repairs.

Another presently available clutch operator is the Arrow Engine Company, CO-46, CO-66, CO-96, CO-106 (the “Arrow”). The Arrow is a clutch operator that is bolted onto the clutch engaging shaft. Like the FW Murphy, the Arrow's design also presents obvious problems. For example, when the clutch comes slightly out of adjustment due to normal use, the clutch's brass sleeve inside the clutch tends to wear to the point of requiring costly repairs. Also, the Arrow has no adjustment.

Another commercially available clutch operator, which is similar to the structural arrangement of the present invention is the Pumpmatic Clutch Operator (the “Pumpmatic”). Instead of using electrical actuators, the Pumpmatic uses air actuators. A major disadvantage of air actuators is that they tend to allow condensation build-up in air lines in cold climates or during cold weather. The Pumpmatic also comprises a very complex and temperamental air compression system that further comprises a solar charging system, compressor, and air tank which poses many problems while exposed to inclement weather.

### BRIEF SUMMARY OF THE INVENTION

The clutch operator of the present invention is a novel mechanical device which comprises two electric actuators to engage and disengage an over-center, in-and-out, PTO style clutch, automatically. The electric actuators are attached to a custom made mounting bracket by attaching means which comprise, but are not limited to, a squeeze clamp system capable of holding the actuators in place. The mounting bracket is attached to the engine by means of multiple clutch housing bolts. A shaft lever attachment or actuating shaft attachment slides onto the clutch's engaging shaft, and is affixed to the mounting bracket. The actuating shaft attachment, when mounted, is in a position to receive the thrust from the actuators thus turning the clutch engaging shaft to engage and disengage the clutch. The actuators are electrically wired to and controlled by a Programmable Logic Controller or a programmable relay and relay setup, after receiving a signal from a separate controller.

The clutch operator of the present invention solves the problems presented by the clutch operators of the prior art, including the FW Murphy and the Arrow. By virtue of not mechanically attaching the electric actuators to the clutch shaft or shaft handle, the present invention does not create constant pressure to the clutch handle while engaged, therefore preventing excessive brass sleeve wear. The clutch operator of the present invention does not use air like the Pumpmatic. Accordingly, the arrangement disclosed herein does not result in condensation build-up in air lines in cold climates or during cold weather. The present invention has the additional advantage of not requiring elaborate air compressor systems which fail consistently in inclement weather.

### BRIEF DESCRIPTION OF THE SEVERAL VIEWS OF THE DRAWINGS

The accompanying drawings, which are incorporated into and form a part of the specification, illustrate an embodiment of the present invention and, together with the description, serve to explain the principles of the invention. The drawings are only for the purpose of illustrating a preferred embodiment of the invention and are not to be construed as limiting the invention.

FIG. 1: is a side view of the invention with the housing removed.

FIG. 2: is a front view of the invention when it is installed on a clutch.

FIG. 3: is a back view of the invention when it is not installed on a clutch.

FIG. 4: is a top view of the invention, including a clutch.

FIG. 5: is a schematic diagram of the electrical system of the invention.

The same reference numbers refer to the same parts throughout the various figures.

### DETAILED DESCRIPTION OF THE INVENTION

The present invention is a clutch operator for the clutch of a rotational motor. The invention can be used to operate a variety of clutch types for both AC and DC motors. The clutch operator functions by moving in the clutch's operating shaft to an activated position to engage the clutch and then moving the clutch's operating shaft to an inactivated position to disengage the clutch.

The present invention comprises a mounting plate (1), a generally T-shaped adapter arm (2) which is attached to the mounting plate with a retaining bracket (11), two electrical linear actuators (3) and (4), two eight-terminal relays (19) and (20), a programmable relay (21) and a battery (23). In the preferred embodiment, the clutch operator also comprises a warning alarm (22) that is activated by the programmable relay (21) when the clutch is engaged. The preferred embodiment also comprises a protective housing (5) and (6) that covers the actuators and electrical components.

In the preferred embodiment of the invention, the clutch operator engages an over-center, in-and-out power take-off clutch. The clutch operator engages the operating shaft (7) of the clutch, turning the clutch on and off remotely, rather than manually. In the preferred embodiment, the clutch operator comprises: two 12 volt linear actuators (3) and (4), each actuator further comprising an adjustable stroke and a thrust rating of 1,010 lb, a mounting plate (1), an adapter arm (2), which is attached to the clutch's operating shaft (7), a programmable relay, two eight-terminal relays, a warning alarm, a 10″ piece of DIN-rail on which the relays are mounted and a two-part protective housing (5) and (6).

The adapter arm (2) runs parallel to the mounting plate (1) of the invention. The adapter arm (2) is generally T-shaped, meaning it has a horizontal portion (15) and a vertical portion (14) extending upwards and downwards from one end of the horizontal portion (15). The distal end (8) of the horizontal portion (15) engages the clutch's operating shaft (7). In the preferred embodiment, distal end of the adapter arm comprises a female spline shaft (12), which engages a male spline shaft (13) on the clutch's operating shaft. This arrangement effectively mates the clutch's operating shaft (7) to the adapter arm (2), creating an extension of the operating shaft that terminates in the proximal end (14) of the adapter arm. The horizontal portion (15) of the adapter arm is affixed to the mounting plate (1) via a retaining bracket (11). The retaining bracket (11) allows some movement in the adapter arm (2) so that the adapter arm can activate and deactivate the operating shaft (7) of the clutch. The proximal end (14) of the adapter arm is perpendicular to the horizontal portion. In the preferred embodiment, the vertical portion (14) of the adapter arm is offset from the horizontal portion (15). The two sides of this vertical portion correspond to the two actuators (3) and (4) of the clutch operator. In the preferred embodiment, the side of the vertical portion that extends above the horizontal portion (15) is the disengaging side (10). The side of the vertical portion that extends below the horizontal portion (15) is the engaging side (9). When the first actuator (4) is activated, the actuator's ram thrusts into the engaging side (9) of the adapter arm (2), which engages the clutch. When the second actuator (3) is activated, that actuator's ram pushes the disengaging side (10) of the adapter arm (2), disengaging the clutch. The first actuator is therefore referred to as the engaging actuator (4) and the second actuator is referred to as the disengaging actuator (3).

The actuators (3) and (4) are mounted on the opposite side of the mounting plate (1) from the adapter arm (2). In the preferred embodiment, each actuator slides into a cylindrical bracket (16) which is welded onto the mounting plate (1). Multiple bolts (17) screw into each bracket (16), holding an actuator in place. The mounting plate (1) comprises two openings (18) which correspond to the placement of the actuators. Each actuator's ram thrusts through the openings (18) to make contact with the corresponding side of the adapter arm's vertical portion (9) or (10) when that actuator is activated.

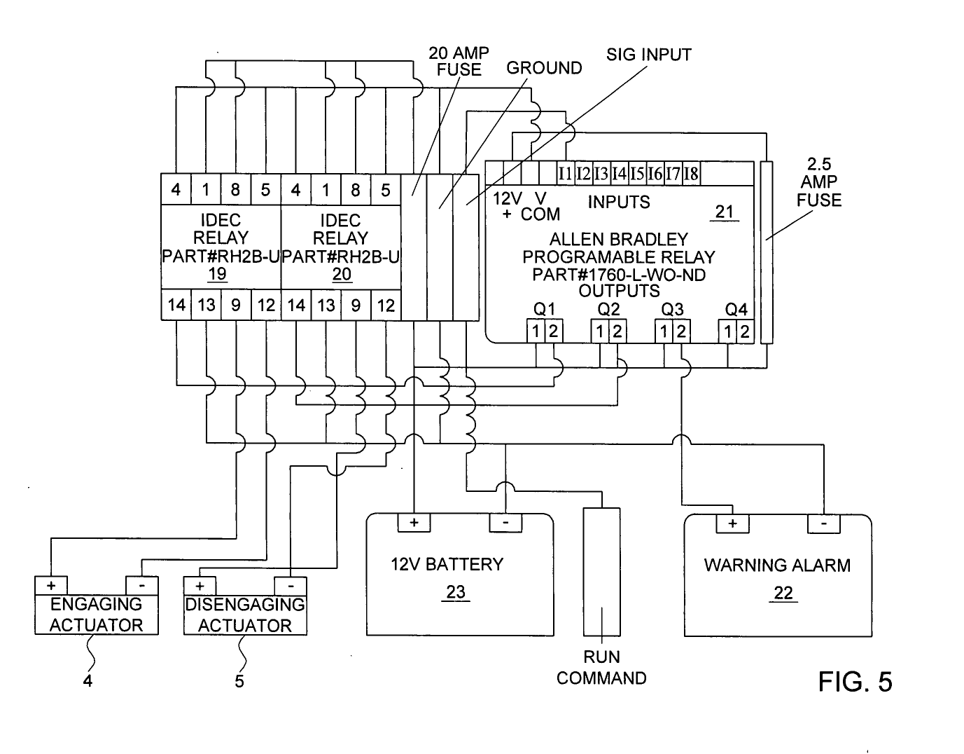

The invention further comprises the electrical controlling means for the clutch operator. FIG. 5 is a schematic of the electrical controlling means and how it electrically interacts with other elements of the invention. FIG. 5 also contains part numbers for off the rack parts. In the preferred embodiment, the electrical controlling means comprises two eight-terminal relays, one for each actuator. These relays, referred to as the engage relay (19) and the disengage relay (20), are controlled by a programmable relay (21). The programmable relay (21) receives an electrical command to engage or disengage the clutch and sends the appropriate signal to the engage or disengage relay. The electrical controlling means also comprises a battery (23). In the preferred embodiment, the programmable relay (21) also controls a warning alarm (22), which sounds when the clutch is engaged. In an alternative embodiment, a Programmable Logic Controller can be used instead of a programmable relay.

One of the novel elements of the present invention is that the pressure on the clutch's operating shaft (7) is not constant throughout the period when the clutch is engaged. When the programmable relay (21) receives the command to engage, it sends the engage relay (19) the command to activate the engaging actuator (4). At this time, the programmable relay (21) also activates the warning alarm (22). The engaging actuator (4) is activated, causing the actuator's ram to thrust out of the actuator, through the opening (18) in the mounting plate (1) and push on the engaging side (9) of the adapter arm (2), engaging the operating shaft (7) of the clutch. After several seconds, the programmable relay (21) causes the engage relay (19) to deactivate the engaging actuator (4), causing the actuator's ram to retract. The adapter arm remains in the activated position, but the pressure of the actuator's ram is no longer exerted against the adapter arm (2) and the clutch's operating shaft (7). When the programmable relay (21) receives the command to disengage the clutch, the disengage relay (20) performs the same process with the disengage actuator (3). The disengage actuator's ram thrusts through the opening (18) in the mounting plate (1) and pushes on the disengaging side (10) of the adapter arm (2), disengaging the operating shaft (7) of the clutch. The disengage relay (20) deactivates the disengaging actuator (3) after several seconds, causing the ram to retract and removing pressure from the disengaging side (10) of the adapter arm (2).

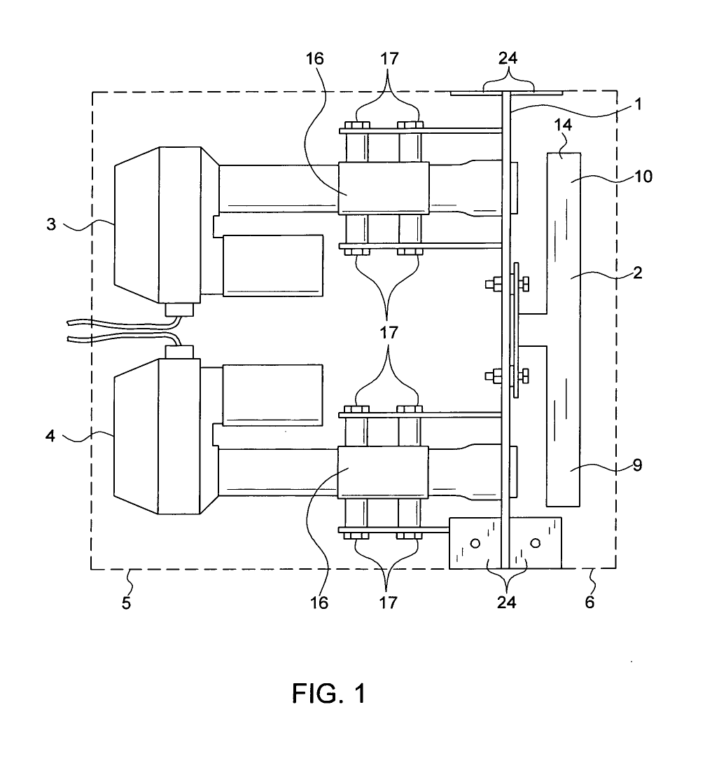

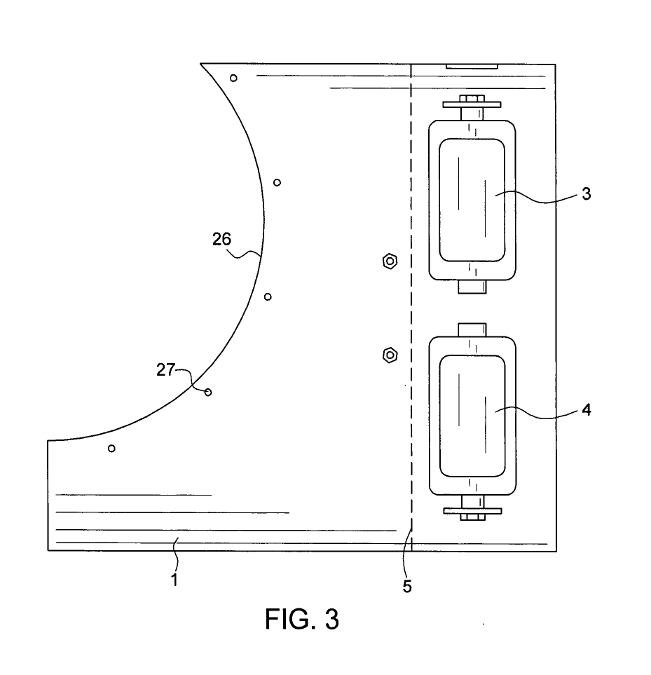

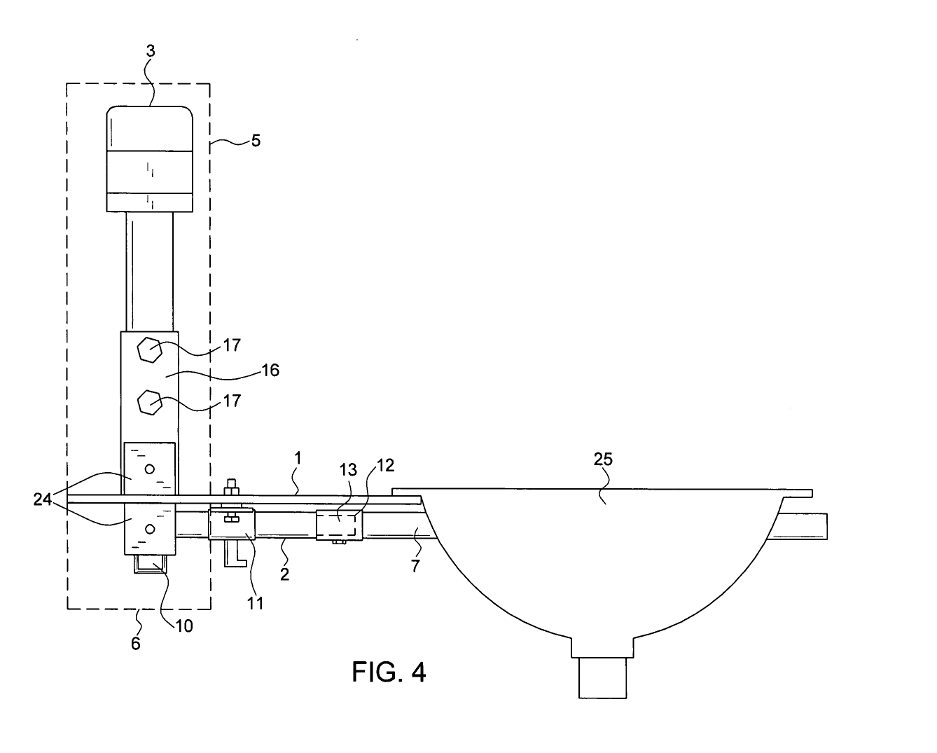

In relation to the figures, FIG. 1 depicts a side view of the invention wherein only a cross-section of the mounting plate (1) is shown. The vertical portion (14) of the adapter arm (2) is visible, showing the way that it aligns with the disengage actuator (3) and the engage actuator (4). The protective housing is depicted as dotted lines. In the preferred embodiment, the protective housing is in fact two sheet metal covers, one on each side of the mounting plate (1). They screw onto the mounting plate via flanges (24), which are welded onto multiple edges of the mounting plate (1). The front housing (6) covers the vertical portion (14) of the adapter arm (2) and a portion of the front of the mounting plate, as also depicted in FIG. 4. The back housing (5) covers the actuators and a portion of the back of the mounting plate, as also depicted in FIGS. 3 and 4.

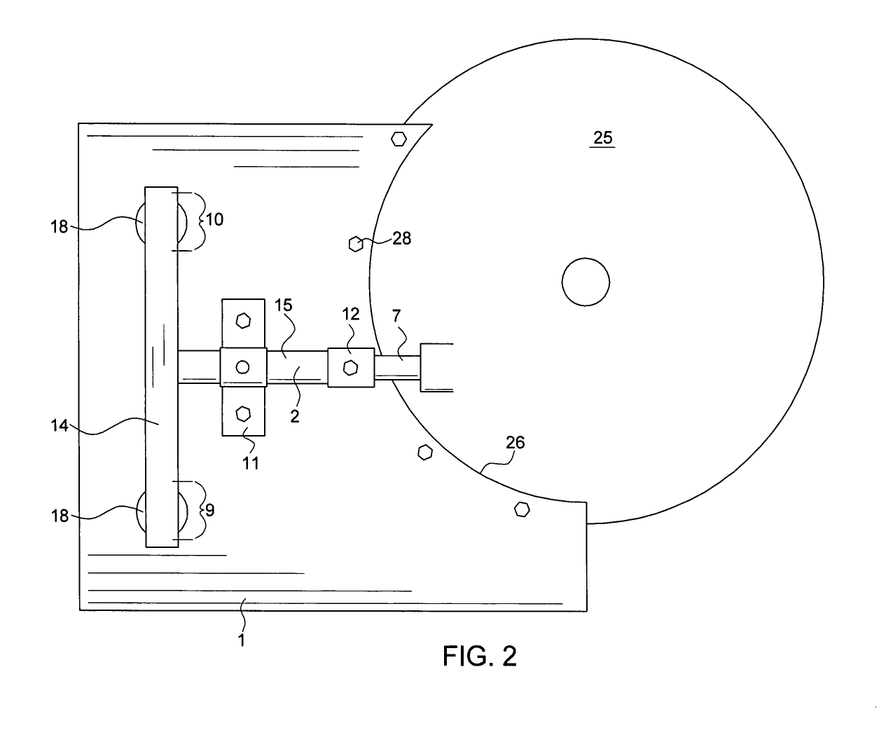

FIG. 2 is a front view of the invention, which only depicts elements on the front side of the mounting plate (1) when mounted to a clutch (25). The openings (18) in the mounting plate (1) are shown in relation to the engaging and disengaging sides of the vertical portion of the adapting arm. In the preferred embodiment, the mounting plate (1) has a cutout edge (26) shaped in such a way to correspond to the shape of the clutch (25). The mounting plate also comprises a series of holes (27) which correspond in placement to the bolt holes of the clutch. Because of the specially shaped edge (26) and the bolt holes (27), the mounting plate can be mounted onto the clutch using the same bolts (28) that attach the clutch (25) to the motor. In most instances, the original bolts that attach the clutch to the motor must be replaced by longer bolts to accommodate the width added by the mounting plate when the clutch operator is installed.

FIG. 3 is a back view of the invention, which only depicts elements on the back side of the mounting plate (1) when it is not mounted to a clutch. The bolt holes (27) are visible because the invention is not mounted.

FIG. 4 is a top view of the invention when mounted to a clutch (25). The disengaging actuator (3), as mounted in the mounting bracket (16) is visible. The splines (12) and (13) which mate the adapting arm (2) to the clutch's operating shaft (7) are depicted.

The method of using the clutch operator of the present invention comprises the steps of: (1) engaging the clutch, which step further comprises the programmable relay receiving a 12 volt signal; (2) having the programmable relay send a signal to activate the engage relay for a period of 8 to 10 seconds which changes the polarity of the engage actuator input to send the actuator ram out; (3) after the 8 to 10 seconds have elapsed, the programmable relay removes power from the engaging relay allowing the engage relay to return to its normal position and allowing the actuator input to return to its normal position; (4) allowing the ram to retract, thus leaving no pressure on the clutch engaging shaft; (5) disengaging the clutch; (6) removing the 12 volt engage signal from the programmable relay, resulting in the programmable relay sending a signal to the disengage relay for a period of 8 to 10 seconds, which in turn changes the polarity of the disengage actuator input to send the actuator ram out; (7) after the last 8 to 10 second period, the programmable relay removes power from the disengage relay allowing the disengage relay to return to its normal position and allowing the actuator input to return to its normal position which retracts the ram.

Generally, although the present invention has been described in detail with particular reference to the above preferred embodiment(s), other embodiments can achieve the same results. Variations and modifications of the present invention will be obvious to those skilled in the art and it is intended to cover all such modifications and equivalents. The entire disclosures of any references, applications, patents, and publications cited above and/or in the attachments, and of the corresponding application(s), are hereby incorporated by reference.

What is claimed is:

1. An electrically actuated clutch operator for an over-center, in-and-out, power take-off clutch, the clutch operator comprising:
a. a mounting plate comprising a front side and a back side;
b. a first electric actuator firmly engaged to the mounting plate's back side and being capable of automatically engaging the clutch;
c. a second electric actuator firmly engaged to the mounting plate's back side capable of disengaging the clutch;
d. a T-shaped adapting arm firmly engaged to the mounting plate's front side and comprising a vertical portion and a horizontal portion, the horizontal portion comprising a distal end and a proximal end, the vertical portion being located at the proximal end of the horizontal portion and comprising an engaging side extending below the horizontal portion and a disengaging side extending above the horizontal portion; the distal end of the horizontal portion of the adapting arm being capable of attaching to a clutch's operating shaft;
e. an electrical control means, the electrical control means being electrically attached to the actuators; and
f. two openings running through the mounting plate, the first opening corresponding to the location of the first actuator and the engaging side of the adapting arm, and the second opening corresponding to the location of the second actuator and the disengaging side of the adapting arm.

2. The electrically actuated clutch operator for an over-center, in-and-out power take-off clutch of claim 1, wherein the electrical control means comprises a relay for the engaging actuator, a relay for the disengaging actuator and a programmable relay capable of controlling the other two relays.

3. The electrically actuated clutch operator for an over-center, in-and-out power take-off clutch of claim 1, wherein the electrical control means comprises a relay for the engaging actuator, a relay for the disengaging actuator and a programmable logic controller capable of controlling the other two relays.

4. The electrically actuated clutch operator for an over-center, in-and-out power take-off clutch of claim 1, wherein a warning alarm is electrically connected to the electrical control means, the warning alarm being capable of sounding an alarm when the clutch operator is activated.

5. The electrically actuated clutch operator for an over-center, in-and-out power take-off clutch of claim 1, wherein the distal end of the horizontal portion of the adapting arm attaches to a clutch's operating shaft by a female spline shaft on the adapting arm and a male spline shaft on the operating shaft.

6. The electrically actuated clutch operator for an over-center, in-and-out power take-off clutch of claim 1, wherein the actuators are linear actuators.

7. A method of using an electrically actuated clutch operator for an over-center, in-and-out power take-off clutch comprising the steps of:
a. engaging a clutch, which step further comprises a programmable relay receiving a 12 volt signal;
b. having the programmable relay send a signal to activate an engaging relay for a period of 8 to 10 seconds which changes the polarity of an engaging actuator input causing the engaging actuator to extend;
c. after the 8 to 10 second period has elapsed, allowing the programmable relay to remove power from the engaging relay allowing the engage relay thus return allowing the engaging relay to return to a normal position and allowing the actuator input to return to a normal position;
d. allowing the engaging actuator to retract, thus leaving no pressure on an operating shaft of the clutch;
e. disengaging the clutch, which further comprises removing the 12 volt engage signal from the programmable relay,
f. having the programmable relay sending a signal to a disengaging relay for a period of 8 to 10 seconds, thus changing the polarity of a disengaging actuator input causing the disengaging actuator to extend;
g. after the 8 to 10 second period has elapsed, causing the programmable relay to remove power from the disengage relay allowing the disengage relay to return to its normal position and allowing the actuator input to return to its normal position; and
h. allowing the disengaging actuator's ram to retract, thus leaving no pressure on the clutch operating shaft.
